(19) United States
(12) Patent Application Publication
(10) Pub. No.: US 2024/0424810 A1
(43) Pub. Date: Dec. 26, 2024

(54) DRYING DEVICE

(71) Applicant: CANON KABUSHIKI KAISHA, Tokyo (JP)

(72) Inventors: JUN KAWAKITA, Chiba (JP); YOSHIAKI HARA, Chiba (JP); KOHEI AOKI, Chiba (JP); HIROSHI KOKUBO, Tokyo (JP); YUSHI SADAMITSU, Tokyo (JP)

(21) Appl. No.: 18/679,991

(22) Filed: May 31, 2024

(30) Foreign Application Priority Data
Jun. 20, 2023 (JP) 2023-100819

(51) Int. Cl. B41J 11/00; F26B 3/06; F26B 15/22

(52) U.S. Cl. CPC B41J 11/0022; F26B 3/06; F26B 15/22

(57) ABSTRACT

A drying device drying a sheet with an ink image includes a belt with through holes penetrating through inner and outer sides thereof, a blowing unit and a suction unit. The blowing unit upward of the belt includes a blowing duct including a blowout opening blowing out the air toward the sheet and a blowing fan blowing toward the blowout opening in the blowing duct. The suction unit downward of the belt includes a first exhaust duct including a first exhaust opening sucking the air from the inner side through the through holes and a suction fan blowing toward the first exhaust opening inside the first exhaust duct. The second exhaust duct is connected to the first exhaust opening and provided with a second exhaust opening exhausting the air to the inside of a casing. The second exhaust opening is disposed to exhaust upward at a position above the belt.

### FIELD OF THE INVENTION AND RELATED ART

The present invention relates to a drying device that dries a sheet on which an image is formed with ink.

An image forming system which forms an image with ink has a process that dries a sheet or blows air onto a sheet, for example, a drying device, which conveys a sheet by a belt and dries the sheet by blowing warm air onto the sheet, is proposed in Japanese Laid-Open Patent Application No. 2012-206304. In this drying device, while a suction and conveying portion, which includes a suction belt with several holes, is suctioning and conveying a sheet, a warm air blowing unit is drying the sheet by blowing air onto a surface of the sheet from above.

Generally, electric power consumption of the blowing warm air unit tends to be high, because of heating air with a heater and blowing warm air onto a sheet. Therefore, it is required to circulate warm air and dry a sheet more efficiently instead of wasting warm air as exhaustion from an apparatus after blowing onto a sheet from a view of heat recycling.

### SUMMARY OF THE INVENTION

To solve the problem as described above, the present invention provides as follows: a drying device for blowing warm air on a sheet on which an image is formed by discharging ink and for drying the sheet, the drying device comprising: a casing; a belt accommodated in the casing and provided with a plurality of through holes which penetrate through an inner peripheral side and an outer peripheral side thereof, and configured to convey the sheet; a blowing unit provided upward of a conveyance surface of the belt in a vertical direction, and provided with a blowing duct including a suction opening for sucking air and a blowout opening for blowing out the air sucked from the suction opening toward the sheet and a blowing fan for blowing from the suction opening toward the blowout opening in the blowing duct; a suction unit provided downward of the conveyance surface of the belt in the vertical direction, and provided with a first exhaust duct including a first exhaust opening for sucking the air from the inner peripheral side of the belt through the plurality of through holes and for exhausting the air sucked and a suction fan for blowing from the plurality of through holes toward the first exhaust opening inside the first exhaust duct; and a second exhaust duct connected to the first exhaust opening of the suction unit and provided with a second exhaust opening for exhausting the air exhausted from the first exhaust opening to an inside of the casing, wherein the second exhaust opening is disposed so as to exhaust upward at a position above the conveyance surface of the belt in the vertical direction.

Further features of the present invention will become apparent from the following description of exemplary embodiments with reference to the attached drawings.

### BRIEF DESCRIPTION OF THE DRAWINGS

FIG. 1 is a cross-sectional schematic view showing an image forming system pertaining to a first exemplary embodiment.

FIG. 2 is a cross-sectional schematic view of a drying module, a printing module, and a fixing module pertaining to the first exemplary embodiment.

FIG. 3 is a perspective view showing a state that an upward opening opens in the drying module pertaining to the first exemplary embodiment.

FIG. 4 is a perspective view showing a drying portion in a warm air blowing unit pertaining to the first exemplary embodiment.

FIG. 5 is a cross-sectional view seen from a side of the drying portion in a warm air blowing unit pertaining to the first exemplary embodiment.

FIG. 6 is a cross-sectional view seen from a front side of the drying belt pertaining to the first exemplary embodiment.

FIG. 7 is a perspective view showing a suction box pertaining to the first exemplary embodiment.

FIG. 8 is a cross-sectional view seen from a side of a drying portion in a warm air blowing unit pertaining to a second exemplary embodiment.

### DESCRIPTION OF THE EMBODIMENTS

### First Embodiment

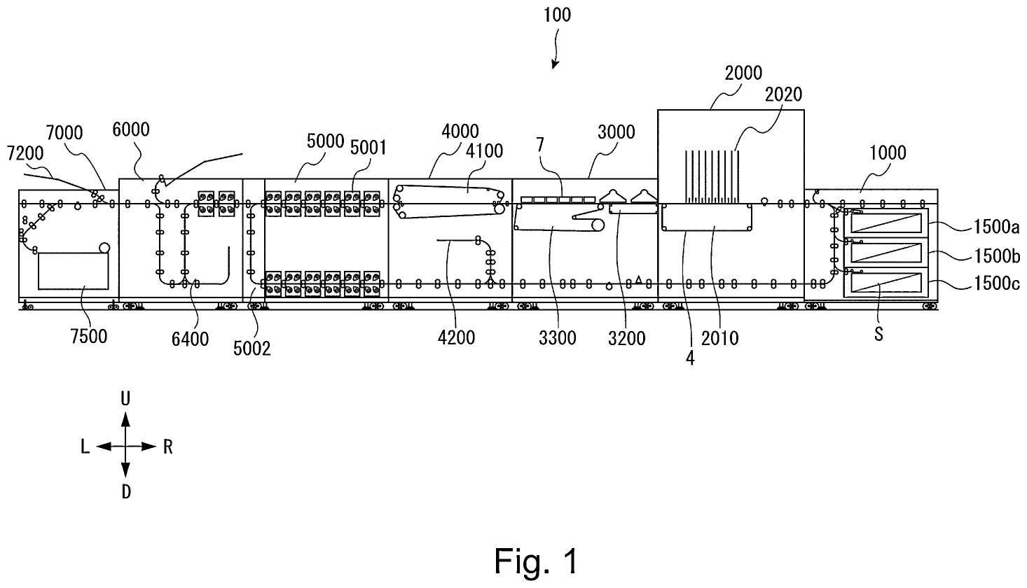

Hereinafter, a first embodiment of the present invention will be described as referring to FIG. 1 to FIG. 7. First, a schematic constitution of an image forming system in a present embodiment will be described as referring to FIG. 1.

### Image Forming System

An inkjet recording system 100 in the present embodiment is adopting an inkjet recording method which forms an image on a sheet by discharging ink and is an inkjet recording apparatus which is so-called sheet feeding type that forms an ink image with two kinds of liquid, which are reaction liquid and ink. The sheet may be a recording material that is able to accept ink, for example, a normal paper, a thick paper, a plastic film such as a sheet for an overhead projector, specific shaped sheet such as an envelope or an index card, or a cloth.

As FIG. 1 showing, the inkjet recording system 100 in the present embodiment is provided with a sheet feeding module 1000, a printing module 2000, and a drying module 3000. Also, the inkjet recording system 100 is provided with a fixing module 4000, a cooling module 5000, a reversing module 6000, and a stacking module 7000. A sheet S fed from the sheet feeding module 1000 goes through each process in each module while the sheet is conveyed along with a conveying passage and is discharged onto the stacking module 7000 lastly.

Note that, each module, from the sheet feeding module 1000 to the stacking module 7000, may include each casing which connects each other to comprise the inkjet recording system 100. Also, the sheet feeding module 1000, the printing module 2000, the drying module 3000, the fixing module 4000, the cooling module 5000, the reversing module 6000, and the stacking module 7000 may be located inside of one casing.

The sheet feeding module 1000 includes sheet storages 1500a, 1500b, and 1500c. The sheet storages 1500a to 1500c is provided as being able to draw toward a front side F where they are installed to accommodate the sheet S. The sheet S is fed by one sheet at a time by a separating belt and a conveying roller in each sheet storage 1500a to 1500c and is conveyed to the printing module 2000. Note that, the sheet storages 1500a to 1500c are not limited to three storages, but may be one storage, two storages, or even four storages or more.

The printing module 2000 includes a pre-image forming registration adjusting portion (not shown), a printing belt unit 2010, and a recording portion 2020. The sheet S conveyed from the sheet feeding module 1000 is adjusted incline and position of the sheet by the pre-image-forming registration adjusting portion and conveyed to the printing belt unit 2010. The recording portion 2020 is located in a position where is facing the printing belt unit 2010 with respect to the conveying passage of the sheet S. The recording portion 2020 is an inkjet recording portion which forms an image onto the sheet S with ink discharged by a plurality of recording heads from above with respect to the sheet S conveyed. A plurality of recording heads discharging ink are aligned along the conveying passage. Five in total of line type recording heads corresponding to four ink colors of Y(yellow), M(magenta), C(cyan), Bk(black) and reaction liquid are included in the present embodiment. The sheet S is ensured clearance from a recording head by that the sheet S is suctioned and conveyed by the printing belt unit 2010.

Note that, a number of the ink colors or the recording heads is not limited to five as described above. Also, some of the inkjet types are able to be adopted, for example, a heating element type, a piezoelectric element type, an electrostatic element type, or a MEMS (micro electro mechanical systems) element type. The inks of each color are supplied from ink tanks (not shown) of each color to the recording heads through ink tubes. Ink includes resin component which is “from 0.1 mass % to 20.0 mass %” based on a total weight of ink, water or water-soluble organic solvent, color material, wax, additives, and so on.

The sheet S on which an image is formed by the recording portion 2020 is detected by an in-line scanner provided in a downstream side of the recording portion 2020 in a conveying direction of the sheet S when the sheet S is conveyed by the printing belt unit 2010. Here, the misalignment or color density of the image formed on the sheet S, and based on the misalignment or color density of the image, any misalignment or color density of the image to be formed on the sheet S is configured to adjust here.

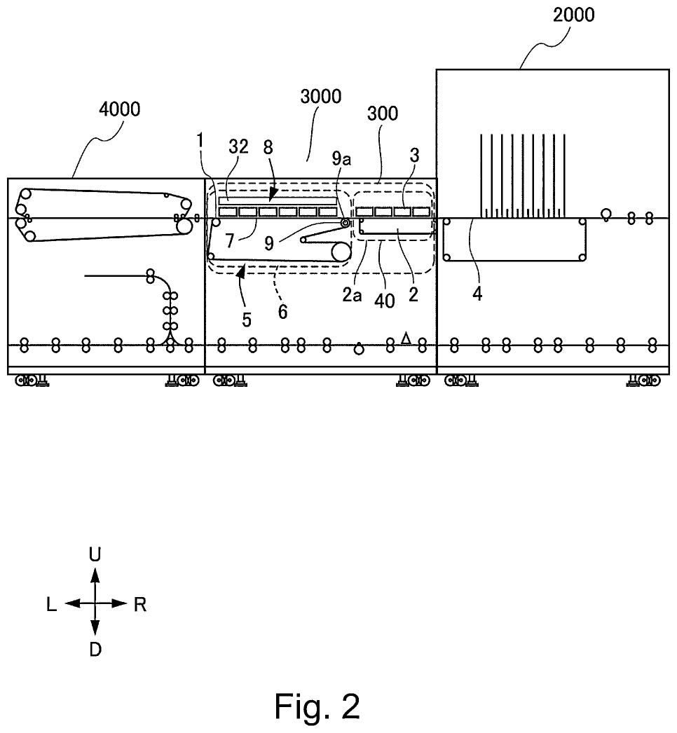

The drying module 3000, which is an example of the drying device, dries the sheet S by blowing warm air onto the sheet S that an image formed with ink discharged. As FIG. 2 showing, the drying module 3000 includes a decoupling portion 40, a drying belt unit 5, and a warm air blowing unit 8. The drying module 3000 reduces a liquidity amount of ink and reaction liquid applied to the sheet S to improve fixing performance of the fixing module 4000 following by. The sheet S that is formed an image is conveyed to the decoupling portion 40 in the drying module 3000. In the decoupling portion 40, air pressure which is air blown from above generates friction between the sheet S and a belt, and the sheet S is conveyed by the belt. Thus, it is configured to prevent the sheet S which is placed on the belt from misalignment by conveying with friction while the sheet S is conveyed through a printing belt unit 2010 and the decoupling portion 40. The sheet S which is conveyed from the decoupling portion 40 is suctioned and conveyed by the drying belt unit 5. Then, the ink and reaction liquid applied on the sheet S is dried by blowing warm air from the warm air blowing unit 8 provided above the belt.

Thus, by that ink and reaction liquid, which are applied on the sheet S, are heated and promoted to evaporate by the drying module 3000, it is suppressed to make so-called cockling which is a line like a frame line made with ink scattering on the sheet S. Note that, as a heater that heats air, a heating wire heater or an infrared heater, for example, are preferrable from a view of safety and energy efficiency. Also, for drying method, in addition to the blowing heated air method, a method that electromagnetic wave (such as ultraviolet light or infrared light) is irradiated on the sheet S or a conduction heat transfer method by contact of a heating element may be combined to constitute.

As FIG. 1 showing, the fixing module 4000 as a fixing system includes a fixing belt unit 4100. The fixing belt unit 4100 fixes ink onto the sheet S which is conveyed from the drying module 3000 by passing through between a heated upper belt unit and a lower belt unit.

The cooling module 5000 includes a plurality of cooling portions 5001 and the cooling portion 5001 cools down the warm sheet S conveyed from the fixing module 4000. The cooling portion 5001 cools down the sheet S by taking outside air into a cooling box with a fan to increase air pressure inside the cooling box and then blowing air onto the sheet S from the cooling box through a nozzle by pressure, for example. The cooling portions 5001 are provided on both sides with respect to the conveying passage of the sheet S and cool down both sides of the sheet S.

The cooling module 5000 includes a conveying passage switching portion 5002. The conveying passage switching portion 5002 switches the conveying passage of the sheet S corresponding to a case which the sheet S is conveyed to the reverse module 6000 or a case which the sheet S is conveyed to a double-side conveying passage for double-side printing which the image is formed on both sides of the sheet S.

The reversing module 6000 includes a reversing portion 6400. The reversing portion 6400 reverses a front and a back side of the sheet S conveyed to change a side of the sheet S when the sheet S is discharged onto the stacking module 7000. The stacking module 7000, which includes a top tray 7200 and a stacking portion 7500, stacks the sheet S conveyed from the reversing module 6000.

During double-side printing, the sheet S is conveyed on the conveying passage which is located below the cooling module 5000 by the conveying passage switching portion 5002. Later, the sheet S is brought back to the printing module 2000 after passing through the double-side conveying passage of the fixing module 4000, the drying module 3000, the printing module 2000, and the sheet feeding module 1000. A double-side conveying portion of the fixing module 4000 is provided with a reversing portion 4200 which reverses the front and the back side of the sheet S. The sheet S, which is brought back to the printing module 2000, is formed an image with ink on another side that an image has not been formed yet, is proceeded from the drying module 3000 through the reversing module 6000, and is discharged onto the stacking module 7000.

### Drying Module

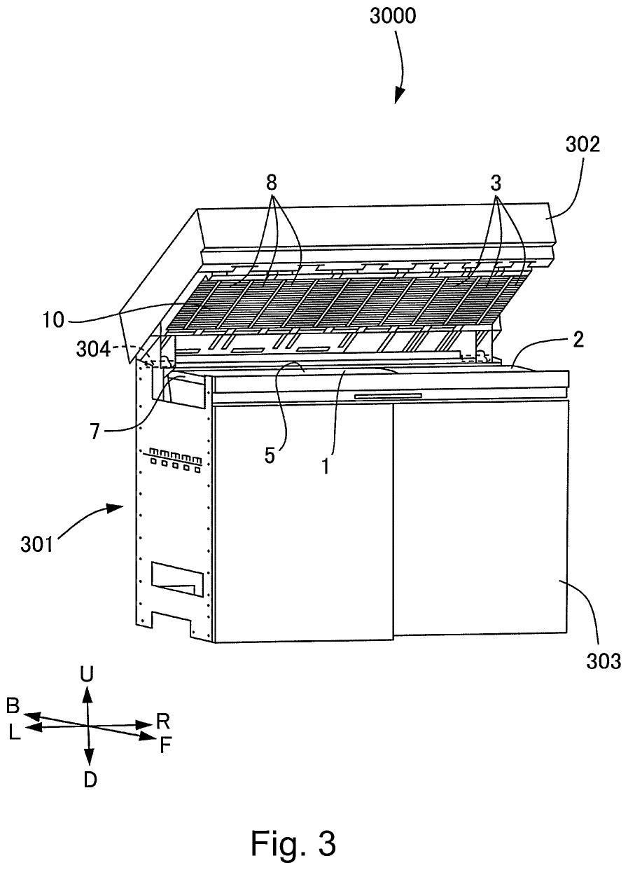

Next, the drying module will be described in detail with FIG. 2 to FIG. 7. FIG. 2 is a schematic view showing a state that the printing module 2000, the drying module 3000, and the fixing module 4000 are connected. FIG. 3 is a perspective view showing the drying module 3000. Note that, in each Figure, each side of the inkjet recording system is indicated as following: a front side as a front side F, a back side as a back side B, a right side viewed from front as a right direction R, a left side viewed from front as a left direction L, an upper side as an upper direction U, and a down side as a down direction D. Also, in the present embodiment, the front side F of the inkjet recording system 100 is the front side where an operating panel is provided and a user stands to operate while using it; the back side B is the back side which is the opposite side of the front side F in a sheet width direction W. The sheet width direction W in here is a front-back direction in the present direction. In similar way, the front side F and the back side B of the drying module 3000 are defined as same as the inkjet recording system 100.

As FIG. 2 showing, the drying module 3000 includes a decoupling portion 40, a drying belt unit 5, and a warm air blowing unit 8. These are referred to as a drying function portion 300 together and are accommodated in a casing 301 (shown in FIG. 3). The drying function portion 300 is provided in the upper part of the drying module 3000 and includes a sheet conveying passage 1 which is a straight passage receives the sheet S discharged from the printing module 2000, dries the sheet S, and then sends the sheet S to the fixing module 4000. In terms of the sheet conveying direction in this sheet conveying passage 1, it functions differently in an upstream portion of the drying function portion 300 from in a downstream portion.

As FIG. 3 showing, the casing 301 includes a first accommodating portion 302 that accommodates the warm air blowing unit 8, a second accommodating portion 303 that accommodates the drying belt unit 5, and a rotational shaft 304 that rotatably connects the first accommodating portion 302 and the second accommodating portion 303 each other. The rotational shaft 304 connects the upper portion of the one side (the back side B) of the second accommodating portion 303 and the lower part of the one side (the back side B) of the first accommodating portion 302 as referring to the sheet conveying direction as a longitudinal direction and with respect to the sheet width direction. By the rotational shaft 304, the first accommodating portion is able to open/close by rotation with the rotational shaft 304 as a center with respect to the second accommodating portion 303. Therefore, the first accommodating portion 302 is possible to open/close from the front side of the apparatus and to improve to perform maintenance.

The decoupling portion 40 as an air blowing device is provided in the upstream of the drying function portion 300. The decoupling portion 40 includes a decoupling belt unit 2 and a cold air blowing unit 3 as an air blowing portion. The cold air blowing unit 3 is provided above the decoupling belt unit 2 in a vertical direction and the decoupling belt unit 2 conveys the sheet S in a roughly horizontal direction. A plurality of cold air units 3 are provided adjacent to each other along the sheet conveying passage. The decoupling belt unit 2 includes a belt 2a which is endless and rotating. By the cold air blowing unit 3 blowing cold air (air) from above the decoupling belt unit 2, the decoupling belt unit 2 presses the sheet S onto the belt 2a and conveys the sheet S. A plurality of holes are provided to vent blowing air from the cold air blowing unit 3 towards a belt opposing side from a blown surface. Note that, air that is not heated by a heater is referred as cold air, hereinafter.

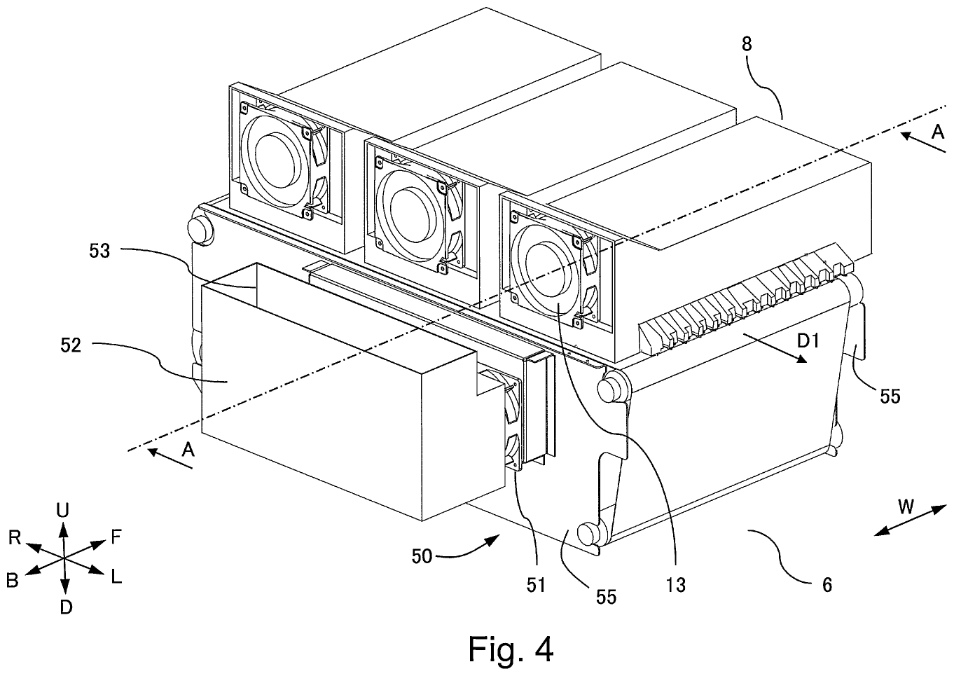

When a leading end of the sheet S reaches the decoupling belt unit 2 in the drying module 3000, a tailing end of the sheet S is yet on a printing belt unit 2010 in the printing module 2000. The printing belt unit 2010 includes a printing belt 4 (shown in FIG. 4) which is endless, suctions and conveys the sheet S. On the printing belt 4, an image forming is executed on the sheet S, and this sheet S is suctioned and conveyed onto the printing belt 4. In order not to cause any disturbances during an image forming process, a force that presses the sheet S onto the belt 2a is weaker than a suctioning force of the printing belt 4 and the belt 2a is driven slightly faster than the printing belt 4. In other words, while the tailing end of the sheet S is on the printing belt 4, the sheet S can slide on the belt 2a always.

On the other hand, once the trailing end of the sheet S leaves a region of the printing belt 4, conveying the sheet S relies on the belt 2a. At this moment, it is necessary to control a blowing force of the cold air blowing unit 3 so the sheet S does not slide off by receiving a resistance force by conveying. Thus, air speed blown onto the sheet S conveyed on the belt 2a from the cold air blowing unit 3 is controlled to be a pre-determined pressure by a pressure sensor (not shown) provided inside the cold air blowing unit 3 and a suction fan (not shown) provided in a suction portion. The cold air blowing unit 3 includes a blowing surface with a lot of blowing holes to vent air to give a pressing force uniformly onto the sheet S.

### Drying Portion

Next, a drying portion 6 will be described with FIG. 2. In the downstream portion of the drying functional portion 300, the drying portion 6 is provided. The drying portion 6 includes a drying belt unit 5 and a warm air blowing unit 8. The several warm air blowing units 8 are provided above the drying belt unit 5 in a vertical direction and adjacent to each other along the sheet conveying passage.

In the drying portion 6, as the sheet S is suctioned onto the drying belt 7 by the drying belt unit 5 suctioning the sheet S, the sheet S is dried by the warm air blowing unit 8 blowing warm air from above in a vertical direction onto the sheet S and conveyed as preventing waving called as cockling. To dry the sheet S quickly, a surface temperature of the drying belt 7 is adjusted to a pre-determined temperature by controlling a heater roller 63 and a heater roller 65, which will be described below, based on a temperature detected by a temperature sensor 67, which will be described below, provided inside the drying belt unit 5. Therefore, the drying belt 7 is configured to heat the sheet S as conveying.

### Warm Air Blowing Unit

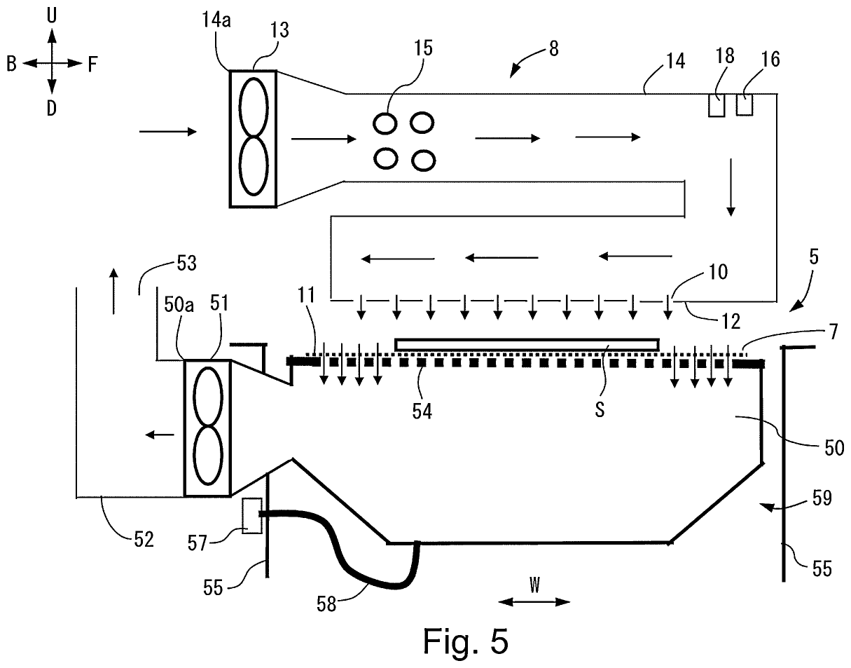

Next, the warm air blowing unit 8 will be described with FIG. 4 and FIG. 5. FIG. 4 is a perspective view of the main components the warm air blowing unit 8 and the drying belt unit 5 as the drying function portions seen from the back direction. In the figures, the left direction L is a sheet conveying passage D1. FIG. 5 is a schematic cross-sectional view of the main components when they are cut with an A-A line in FIG. 4. Arrows in FIG. 5 indicate a flow of air. The warm air blowing unit 8 includes a blowing fan 13, a blowing duct 14, a heater 15, a temperature sensor 16, and so on. The blowing fan 13 is an axial fan in the present embodiment. However, it is not limited to the axial fan, but may be other blowing air resources such as a sirocco fan. The heater 15 is a sheath heater in the present embodiment. However, it is not limited to the sheath heater, but may be other heat sources such as a kanthal heater.

The blowing duct 14 is installed with the heater 15 and the temperature sensor 16 inside and the end of the blowing duct 14 is connected to the exhausting side of the blowing fan 13. In other words, the blowing fan is provided in the upstream end of the blowing duct 14. The heater 15 is provided in the downstream side of a blowing air passage of the blowing fan 13. The heater 15, which is an example of a heating portion, is provided in the downstream of the blowing fan 13 in the blowing duct 14 to heat up air blown through the blowing duct 14.

A surface that faces the sheet S in further downstream of the heater 15 is a blowing surface 12 on which a plurality of blowing holes 10 are formed. In the present embodiment, the whole of blowing duct 14 is roughly formed as a shape of a letter U in a side way as seen in the sheet conveying direction. The upper portion of the blowing duct 14 is a suction side which connects the blowing fan 13 and the lower portion is an exhausting side in which a blowing holes 10 are formed. The temperature sensor 16 is installed on the top side in the upper portion of the blowing duct 14. Also, a pressure sensor 18 which detects pressure inside the blowing duct 14 is provided adjacent to the temperature sensor 16.

Therefore, either air from outside or inside the apparatus blown from the blowing fan 13 is heated by the heater 15 and blown onto the drying belt 7 in the drying belt unit 5 or onto the sheet S on the drying belt 7 through the blowing holes 10 in the blowing duct 14. The blowing holes 10 are provided in a region that covers the widest sheet width of the sheet S as being possible to blow air onto a whole of the sheet S that includes the widest size of the width. The temperature and the pressure in the blowing duct 14 are detected by the temperature sensor 16 and the pressure sensor 18 and a heat value of the heater 15 and the rotating speed of the blowing fan 13 are controlled by a controlling portion (not shown) corresponding to the detected values. Therefore, the warm air blowing unit 8 blows warm air onto the sheet S to press the sheet S onto the drying belt 7 and dries ink on the sheet S. Note that, a distance between a position where suction ends of the printing belt 4 and a position where suction starts of the drying belt 7 is configured to be longer than the longest size of length of the sheet S.

In other words, the warm air blowing unit 8, which is an example of an air blowing unit, is provided above the drying belt unit 5 in a vertical direction and includes the blowing duct 14 and the blowing fan 13. The blowing duct 14 includes a suction opening 14a that suctions air and the blowing holes 10 that are blowing openings that blows air suctioned from the suction opening 14a onto the sheet S conveyed by the drying belt 7. The blowing fan 13 blows air inside the blowing duct 14 from the suction opening 14a towards the blowing holes 10.

### Drying Belt Unit

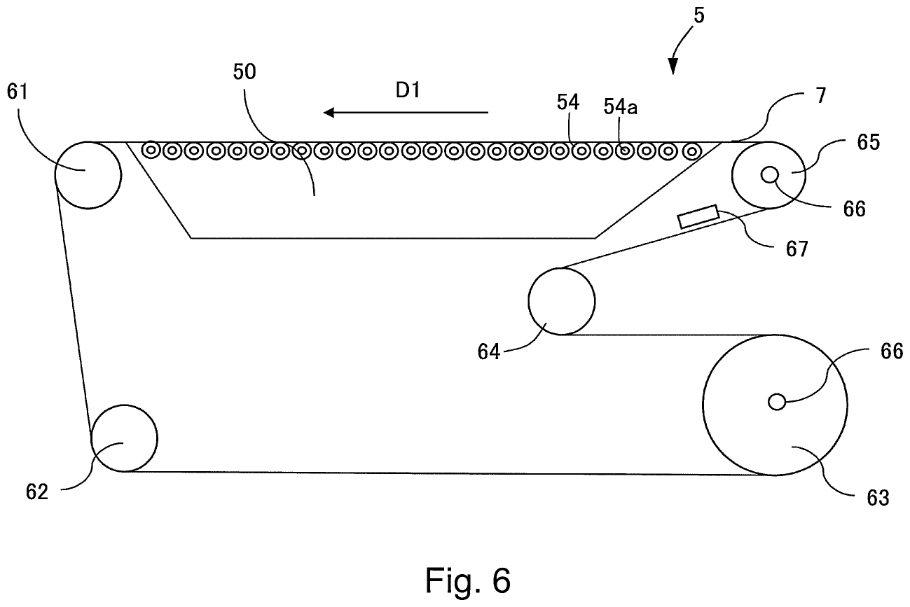

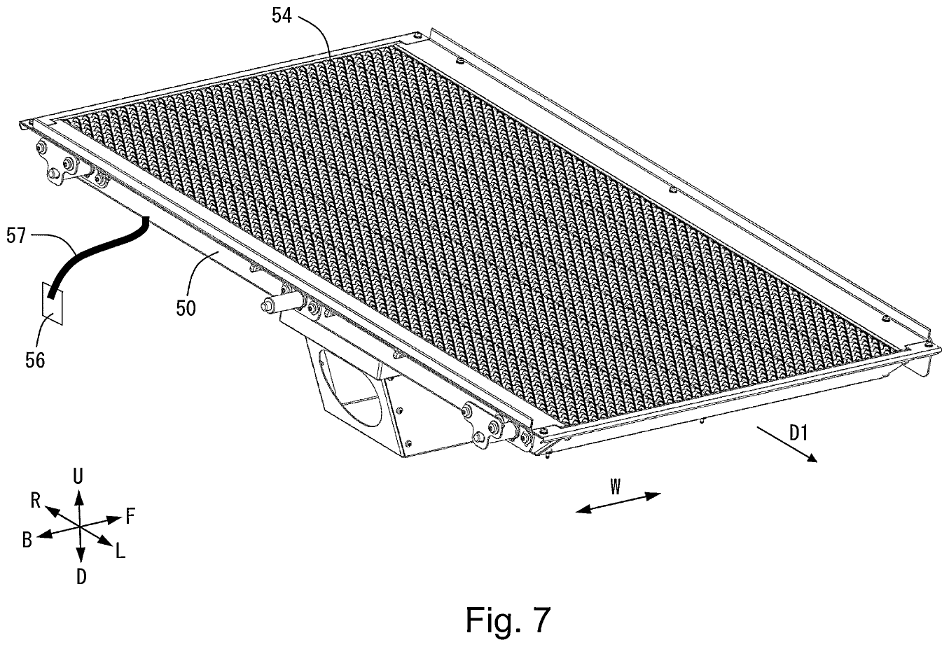

Next, the drying belt unit 5 will be described with FIG. 6 and FIG. 7. FIG. 6 is a cross-sectional view of the drying belt unit 5 and FIG. 7 is a perspective view of a suction box 50. The left direction L is the same as the sheet conveying direction D1 in both figures. The drying belt unit 5 includes the drying belt 7 which is rotational endless conveying belt, a plurality of rollers which stretches the drying belt 7, and a heater 66 to heat the drying belt 7 and conveys the sheet S as heating by the drying belt 7. The drying belt 7, which is an example of a hollow rotational body and a conveying belt, includes suction holes 11 which are a plurality of through holes penetrating between the inner peripheral and the outer peripheral. The drying belt unit 5, which is an example of a sheet conveying portion, is accommodated in the casing 301, includes the drying belt 7, and conveys the sheet S by the drying belt 7 rotating.

In the present embodiment, the drying belt unit 5 includes five rollers: a driving roller 61, a tension roller 62, a heater roller 63, a counter roller 64, a heater roller 65, which stretch the drying belt 7. The driving roller 61 is driven by a motor (not shown) to convey the drying belt 7 by the driving roller 61 rotating. The tension roller 62 is a roller that urges the drying belt 7 towards outside with a spring (not shown) to prevent the drying belt 7 from warping. Each heater roller 63 or 65 includes a heater 66 inside and conducts heat to the drying belt 7. Each heater is comprised of a halogen heater, for example. In the upstream of the heater roller 65, a temperature sensor 67 is provided to detect temperature of the drying belt 7. Compared the heater roller 63 with the heater roller 65, the heater roller 63 has a larger diameter. Thus, the heater roller 63 mainly heats the drying belt 7 and the heater roller 65 adjusts temperature of the drying belt 7.

The counter roller 64 is a roller that contacts the drying belt 7 from outside to increase the length which the drying belt 7 contacts the heater roller 63 and the heater roller 65 so as to efficiently conduct heat to the drying belt 7. Also, the counter roller 64 includes a steering function which prevents shifts of the drying belt 7 by swinging an axis end of the counter roller 64 up and down with a motor (not shown).

Between the heater roller 65 and the driving roller 61, the suction box 50 is provided. The top side of the suction box 50 is open and a plurality of belt rollers 54 are aligned there. The belt roller 54 is made of Polytetrafluoroethylene (PTFE) as a diameter is about 10 mm and a length in width direction is about 10 mm, for example. A plurality of belt rollers 54 are provided as independently rotatable on a shaft 54a at intervals about 10 mm. Further, the shaft 54a, which is provided with a plurality of belt rollers 54, is placed as its longitudinal direction is along the sheet width direction W and a plurality of the shafts 54a are aligned in the sheet conveying direction. As seen from above at this time, each belt roller 54 included on the adjacent shafts 54a is positioned alternately like zigzag. Air can flow in a vertical direction though gaps between the belt rollers 54 aligned like zigzag and the exposed portions of the shafts 54a in between each belt roller 54.

In the present embodiment, the drying belt 7 are supported by the belt rollers 54 in the suction box 50. In other words, the whole plurality of the belt rollers 54, which is an example of a supporting surface portion, supports the region of the drying belt 7 that is conveying the sheet S. Since the belt rollers 54 themselves are rotatable, it is possible to suppress wearing of the drying belt 7 by sliding on the belt rollers 54 and contribute to improve the product life of the drying belt 7. Note that, though the top side of the suction box 50 comprises a plurality of belt rollers 54 provided in the present embodiment, it is not limited to this but may comprise a top board including a plurality of through holes, for example.

As FIG. 4 showing, as the suction fan 51 is provided in a back side B of the suction box 50. Air, which is inside the suction box 50, is exhausted and air, which is above the gaps of the belt rollers 54, is suctioned by driving the suction fan 51. Also, the suction holes 11 are formed on the drying belt 7 and the sheet S on the drying belt 7 is suctioned and hold onto the drying belt 7 through the gaps of the belt rollers 54 and the suction holes 11.

Each suction hole 11 on the drying belt 7 has: 0.4 mm diameter, 3.0 mm to 4.0 mm intervals between each other in the sheet conveying direction D1, and 2.5 mm to 3.0 mm intervals between each other in the sheet width direction W. The suction holes 11 on drying belt 7 are aligned like almost zigzag each other seen from above and whole area of holes equals to about 1.4% of the surface area of the drying belt 7. The pressure sensor 57, which detects pressure in the suction box 50 through a tube 58, is provided under the suction box 50. The suction pressure at the suction holes 11 is between 1500 Pa and 2000 Pa, and the rotational speed of the suction fan 51 is controlled by a control portion (not shown) corresponding to an output value of the pressure sensor 57.

In the present embodiment, the suction box 50 and suction fan 51 are equivalent to a suction unit 59. In other words, the suction unit 59 is provided in the drying belt unit 5 and includes the suction box 50 and the suction fan 51. The suction box 50, which is an example of a first exhausting duct, suctions air through a plurality of hole portions (gaps of the belt rollers) from the inner peripheral side of the drying belt 7 and includes a first exhaust opening 50a that exhausts the suctioned air. The suction fan 51 blows air towards the first exhaust opening 50a from a plurality of the hole portions of the suction box 50.

Thus, a plurality of belt rollers 54 include a plurality of the hole portions and attract the drying belt 7 onto a plurality of the belt rollers 54 by suctioning air through the hole portions from the side of the drying belt 7 (the conveying belt side) in the present embodiment. Also, a plurality of belt rollers 54 attract the sheet S onto the drying belt 7 by suctioning air though a plurality of suction holes 11 of the drying belt 7.

### Circulating Constitution

Next, a constitution of circulating exhaustion of the suction box 50 in the present invention will be described in detail with FIG. 6 and FIG. 7. The suction box 50 is provided in the inner peripheral side of the drying belt 7. The belt rollers 54, which support the drying belt 7, are provided on the top side of the suction box 50 and the suction fan 51 is connected to the back side (referred in FIG. 4). The suction box 50 itself is located and supported in between a drying belt frame 55 fixed with a casing. The suction fan 51 is connected with the suction box 50 through a hole of the drying belt frame 55 from outside of the back side of the drying belt frame 55 with respect to the sheet width direction W.

An exhaustion duct 52 is connected to the back side of the suction fan 51. The exhaustion duct 52 is formed as an exhaust opening 53 opens towards a vertical direction. The exhaust opening 53 is provided above the drying belt 7. In other words, the exhaustion duct 52, which is an example of a second exhaustion duct, is connected to the first exhaust opening 50a of the suction unit 59 and includes the second exhaust opening 53 which exhausts air that discharged from the first opening 50a into inside of the casing 301. The second exhaust opening 53 is provided as it exhausts to above at a position where is an upper side of the sheet conveying direction of the sheet S guided by the drying belt 7 with respect to the vertical direction in the present embodiment. Also, the second exhaust opening 53 is provided in the back side B of the casing 301 where is an opposite side of the front side F of the casing 301 (shown in FIG. 3) far back from the drying belt unit 5 in the sheet width direction W that crosses to the sheet conveying direction. Further, the suction opening 14a of the warm air blowing unit 8 is configured to be provided in the far back from the drying belt unit 5 to the bac side B of the casing 301 in the sheet width direction and be also provided above the second exhaust opening 53 in the vertical direction inside the casing 301 as well.

The suction fan 51 is provided to exhaust air inside the suction box 50 towards outside of the suction box 50 where is the side of the exhaustion duct 52. Since the suction box 50 is sealed except the gaps of the belt rollers 54 on the top side of the suction box 50 or an opening to the suction fan 51, the suction box 50 suctions air from the gaps of the belt rollers 54 and the suction hole 11 of the drying belt 7 on the belt rollers 54 when the suction fan 51 drives. Note that, an air flow rate blown from the warm air blowing unit 8 is configured to be more than the air flow rate suctioned by the suction box 50. In other words, the air flow rate of the suction fan 51 is less than the air flow rate of the blowing fan 13. However, it is not limited to this, either the air flow rate of the suction fan 51 may be as much as the air flow rate of the blowing fan 13, or the air flow rate of the suction fan 51 may be more than the amount of the blowing fan 13 depending on other conditions.

Here, in the case that the sheet S is on the drying belt 7, the sheet S is suctioned and fixed onto the drying belt 7 and is conveyed corresponding to the rotation of the drying belt 7. In the both ends in the sheet width direction W of the drying belt 7, where the sheet S is not on, the warm air blown from the blowing holes 10 is suctioned into the suction box 50 as the way it is, and then the warm air is taken back into the apparatus through the suction fan 51 from the exhaust opening 53. Later, the warm air is suctioned by the blowing fan 13 of the warm air blowing unit 8 and is blown again out of the blowing holes 10 as warm air for blowing the sheet S. By making warm air circulate without exhausting out of the apparatus as described above, the heat energy can be used efficiently and the energy consumption can be reduced as comparing to heat up outside air.

As described above, according to the drying module 3000 in the present embodiment, the second exhaust opening 53 is located at the position where is upper side in the vertical direction than the sheet conveying passage of the sheet S that is guided by the drying belt 7 so as to exhaust air above. Also, the second exhaust opening 53 is located in the back side B of the casing 301 which is the opposite side of the of the front side F of the casing 301 and is far back from the drying belt unit 5 in the sheet width direction W that crosses the sheet conveying direction. In other words, the second exhaust opening 53 is located in the position where it does not cover the sheet passing region seen from above. Thus, exhaustion from the drying belt unit 5 is not blown directly onto the sheet S on the drying belt 7 and the sheet S is hardly affected by air turbulence such as an upward air current caused by warm air exhaustion as well. Thus, it is possible to implement stable conveying the sheet S on the drying belt 7 without lifting off even if warm air is circulated inside the casing 301. Therefore, it is possible to stably convey the sheet S even when air is circulated inside the apparatus.

Also, since the second exhaust opening 53 is located in the back side B of the apparatus, exhaustion air is hardly blown towards a user. Further, since the second exhaust opening 53 is located in the back side B, the exhaustion duct 52 is not needed to be provided in the front side F of the apparatus. Therefore, it is possible to improve maintenance performance.

Also, according to the drying module 3000 in the present embodiment, the suction opening 14a of the warm air blowing unit 8 is located in the back side B of the casing 301 where is far back from the drying belt unit 5 and above the second exhaust opening 53 in the vertical direction inside the casing 301. Thus, it is possible to efficiently suppress air to flow towards the sheet S because air exhausted from the second exhaust opening 53 becomes easier to be suctioned from the suction opening 14a.

Also, according to the drying module 3000 in the present embodiment, the air flow rate of the suction fan 51 is configured to be less than air flow rate of the blowing fan 13. Thus, it is possible to efficiently suppress air exhausted from the second exhaust opening 53 to flow towards the sheet S because the amount of exhaustion from the second exhaust opening 53 is less than the amount of suction air from the suction opening 14a.

Note that, though the case that the drying belt 7 is applied as a rotation body was described in the present embodiment described above, it is not limited to this. For example, a rotational drum may be applied to. In this case, a lot of holes are provided on a surface of the drum and configured to suction the sheet S from the inner peripheral side and attract the sheet S on the surface of the drum.

Also, a constitution of an image forming system for a sheet feeding printing as shown in FIG. 1 was described in the present embodiment described above. However, the image forming system is not limited to the sheet feeding printing apparatus, a continuous sheet printing apparatus may be applied as well.

### Embodiment 2

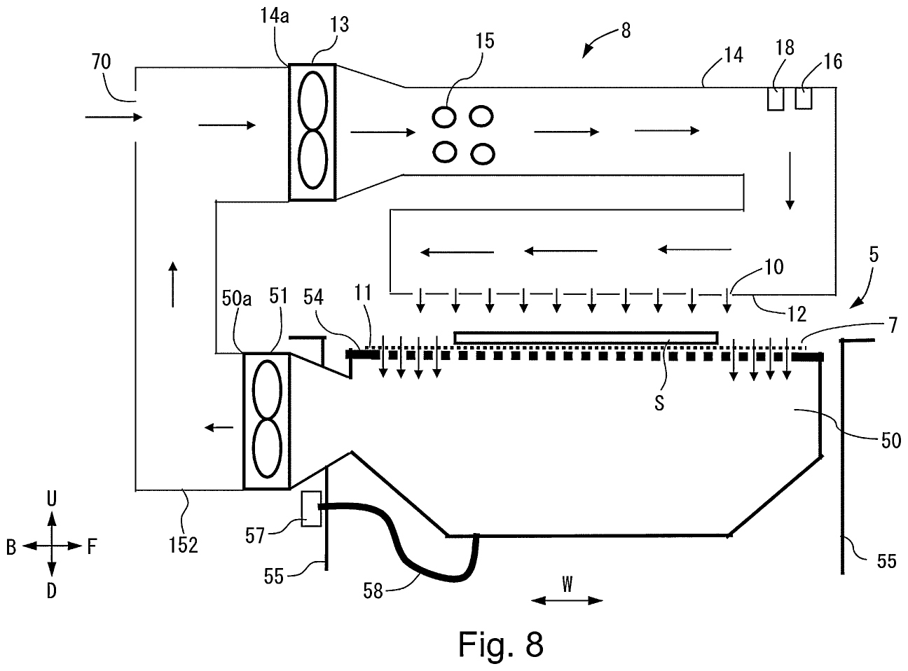

Next, a second embodiment in the present invention will be described in detail with FIG. 8. In the present embodiment, a constitution that includes a connecting duct 152, which connects a first exhaust opening 50a and a blowing duct 14, is different from the constitution in the embodiment 1. However, since other constitutions except the connecting duct 152 are the same as the embodiment 1, same reference numbers are given and detail descriptions are omitted.

As FIG. 8 showing, the connecting duct 152 that connects the first exhaust opening 50a as an exhaust outlet and a suction opening 14a is provided in the present embodiment. The connecting duct 152 is a duct guides exhausted air from the first exhaust opening 50a towards the blowing duct 14. The connecting duct 152 is located in the back side B of the casing 301 that is opposite side of the front side F of the casing 301 and far back from the drying belt unit 5 in the sheet width direction W. The connecting duct 152 includes an opening portion 70 which suctions inside air of the casing 301 as communicating with the inside of the casing 301 in the present embodiment. Note that, the opening portion 70 is not necessary to exist.

As described above, according to the present embodiment, it is possible to circulate warm air efficiently inside the casing 301 without diffusing exhausted air of the suction box 50 and to decrease to affect the sheet S on the drying belt 7.

Note that, though the connecting duct 152 connects the first exhaust opening 50a and the suction opening 14a in the present embodiment, it is not limited to this but anywhere of the blowing duct 14 and the first exhaust opening 50a may be connected.

Also, in the present embodiment, though the opening portion 70 is open towards the inside of the casing 301, it is not limited to this. For example, the opening portion 70 may be provided near the blowing warm air unit 8 of the connecting duct 152 to intake outside air.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-100819 filed on June 20, 2023, which is hereby incorporated by reference herein in its entirety.

What is claimed is:

1. A drying device for blowing warm air on a sheet on which an image is formed by discharging ink and for drying the sheet, the drying device comprising:
a casing;
a belt accommodated in the casing and provided with a plurality of through holes which penetrate through an inner peripheral side and an outer peripheral side thereof, and configured to convey the sheet;
a blowing unit provided upward of a conveyance surface of the belt in a vertical direction, and provided with a blowing duct including a suction opening for sucking air and a blowout opening for blowing out the air sucked from the suction opening toward the sheet and a blowing fan for blowing from the suction opening toward the blowout opening in the blowing duct;
a suction unit provided downward of the conveyance surface of the belt in the vertical direction, and provided with a first exhaust duct including a first exhaust opening for sucking the air from the inner peripheral side of the belt through the plurality of through holes and for exhausting the air sucked and a suction fan for blowing from the plurality of through holes toward the first exhaust opening inside the first exhaust duct; and
a second exhaust duct connected to the first exhaust opening of the suction unit and provided with a second exhaust opening for exhausting the air exhausted from the first exhaust opening to an inside of the casing,
wherein the second exhaust opening is disposed so as to exhaust upward at a position above the conveyance surface of the belt in the vertical direction.

2. The drying device according to claim 1, wherein the suction opening is disposed on a further backside of the casing than the conveyance surface of the belt with respect to a widthwise direction of the sheet and above the second exhaust opening in the vertical direction inside the casing.

3. The drying device according to claim 1, wherein an air flow rate of the suction fan is smaller than an air flow rate of the blowing fan.

4. The drying device according to claim 1, wherein the belt is an endless conveyance belt configured to convey the sheet by rotation of the belt,
wherein the first exhaust duct includes a supporting surface portion configured to support an area of the belt on which the sheet is conveyed, and
wherein the supporting surface portion provided with a plurality of hole portions and configured to attract the belt to the supporting surface portion by sucking the air from a side of the belt through the plurality of hole portions and to attract the sheet to the belt by sucking the air through the through holes.

5. The drying device according to claim 2, wherein the casing includes a first accommodating portion configured to accommodate the blowing fan, a second accommodating portion configured to accommodate a sheet conveyance portion and the suction unit, and a rotating shaft rotatably connecting the first accommodating portion and the second accommodating portion with each other,
wherein the rotating shaft, in a conveyance direction of the sheet as a longitudinal direction, connects an upper portion of the second accommodating portion on one side and a lower portion of the first accommodating portion on the one side with respect to the widthwise direction of the sheet,
wherein the first accommodating portion is provided so as to be openable and closable by rotation about the rotating shaft with respect to a second accommodating portion, and
wherein the backside is the one side.

6. The drying device according to claim 1, wherein the second exhaust opening is disposed on a further backside of the casing opposite to a frontside of the casing than the sheet conveyance portion with respect to a widthwise direction of the sheet crossing to a conveyance direction of the sheet.

7. The drying device according to claim 1, wherein the blowing unit includes a heating means, and
wherein the blowout opening blows out the air sucked from the suction opening and heated by the heating means toward the sheet.

8. A drying device for blowing warm air on a sheet on which an image is formed by discharging ink and for drying the sheet, the drying device comprising:
a casing;
a belt accommodated in the casing and provided with a plurality of through holes which penetrate through an inner peripheral side and an outer peripheral side thereof, and configured to convey the sheet;
a blowing unit provided upward of a conveyance surface of the belt in a vertical direction, and provided with a blowing duct including a suction opening for sucking air and a blowout opening for blowing out the air sucked from the suction opening toward the sheet conveyed by a rotatable member and a blowing fan for blowing from the suction opening toward the blowout opening in the blowing duct;
a suction unit provided downward of the conveyance surface of the belt in the vertical direction, and provided with an exhaust duct including an exhaust opening for sucking the air from the inner peripheral side of the belt through the plurality of through holes and for exhausting the air sucked and a suction fan for blowing from the plurality of through holes toward the exhaust opening inside the exhaust duct; and
a connecting duct configured to connect the exhaust opening and the blowing duct and to guide the air exhausted from the exhaust opening to the blowing duct, the connecting duct being disposed on a further backside of the casing opposite to a frontside of the casing than a sheet conveyance portion with respect to a widthwise direction of the sheet crossing to a conveyance direction of the sheet.

9. The drying device according to claim 8, wherein the connecting duct is connected to the exhaust opening and the suction opening and provided with an opening portion configured to suck an inside air of the casing by communicating with an inside of the casing.

10. The drying device according to claim 8, wherein an air flow rate of the suction fan is smaller than an air flow rate of the blowing fan.

11. The drying device according to claim 8, wherein the belt is an endless conveyance belt configured to convey the sheet by rotation of the belt,
wherein the exhaust duct includes a supporting surface portion configured to support an area of the conveyance belt on which the sheet is conveyed, and
wherein the supporting surface portion provided with a plurality of hole portions and configured to attract the conveyance belt to the supporting surface portion by sucking the air from a side of the conveyance belt through the plurality of hole portions and to attract the sheet to the conveyance belt by sucking the air through the through holes.

12. The drying device according to claim 8, wherein the casing includes a first accommodating portion configured to accommodate the blowing fan, a second accommodating portion configured to accommodate the sheet conveyance portion and the suction unit, and a rotating shaft rotatably connecting the first accommodating portion and the second accommodating portion with each other,
wherein the rotating shaft, in a conveyance direction of the sheet as a longitudinal direction, connects an upper portion of the second accommodating portion on one side and a lower portion of the first accommodating portion on the one side with respect to the widthwise direction of the sheet,
wherein the first accommodating portion is provided so as to be openable and closable by rotation about the rotating shaft with respect to the second accommodating portion, and
wherein the backside is the one side.

13. The drying device according to claim 8, wherein the blowing unit includes a heating means, and
wherein the blowout opening blows out the air sucked from the suction opening and heated by the heating means toward the sheet.
